(19) United States
(12) Patent Application Publication
(10) Pub. No.: US 2006/0146534 A1
(43) Pub. Date: Jul. 6, 2006

(54) Solar powered lamp

(76) Inventors: Richard G. Morton, San Diego, CA (US); John R. Ross, Del Mar, CA (US)

Correspondence Address: JOHN R. ROSS, PO BOX 2138, DEL MAR, CA, 92014, US

(21) Appl. No.: 11/030,017

(22) Filed: Jan. 5, 2005

(51) Int. Cl. F21V 33/00

(52) U.S. Cl. 362/253

(57) ABSTRACT

An improved solar powered LED-based lighting fixture providing substantial increases in the apparent light output compared to prior art solar powered LED-based lighting fixtures. This improvement in preferred embodiments results from the addition of inexpensive spherical lenses that create a large number of images of LED light sources, each image having substantially reduced brightness as compared to the real LED light source. These images with substantially reduced brightness result in beautiful patterns, that still appear very bright to a night time observer, because the LED source itself is in fact too bright to look at directly. In a preferred embodiment ten plastic 0.5-inch spherical lenses are positioned along the bottom edge of the cone at the bottom of lamp. Each of these spherical lenses creates multiple images of the single source LED, all nearly as bright as the source itself. As a result the perceived delivery of light intensity to an observer is multiplied by a factor of approximately 10 times. In other preferred embodiments, conventional primary cell alkaline batteries are used in place of rechargeable Nickel-Cadmium batteries, whereby the battery cost is cut in half and the energy storage capacity tripled. Applicant has discovered that the conventional primary cell alkaline batteries are safely and effectively recharged by the solar cell.

### BACKGROUND OF THE INVENTION

Landscape lighting has long been popular as a nighttime enhancement to the grounds surrounding private homes or businesses. These generally require running wires underground to supply electrical power, and have typically employed conventional, incandescent tungsten filament lamps from which the radiated visible output energy is about one percent of the electrical power supplied. The remaining approximately 99% of the electrical energy is converted to heat and longer wavelength invisible radiation. Much higher efficiency light emitting diode (LED) sources of illumination are now available from many sources and are widely used in industrial and consumer products. Solar cells are well known and are commercially available from many sources to convert sunlight to electrical energy for charging batteries. Electronic components are also available and well known for efficiently charging batteries with solar power sources. These technologies have permitted commercial production of products such as solar powered flashlights and landscape lighting fixtures that require no underground wiring (providing freedom of lamp placement). Solar powered LED-based landscape lighting fixtures are supplied by several manufacturers and are available at retail outlets such as Home Depot. A popular solar powered LED landscape light fixture is the “tiered path” model supplied by Hampton Bay that is available at Home Depot with stores throughout much of the United States. The light fixture includes a state of the art solar cell, two high performance NiCad rechargeable 1.25-volt AA batteries and a metal pointed stake for “planting” the lamp anywhere in the ground.

A drawing of this light fixture 50 is shown in FIG. 1A. FIG. 1B is schematic drawing showing the functioning parts of light fixture 50 and FIG. 2 is a drawing describing the function of the lamp. As shown in FIG. 1B, a 2-inch×2-inch solar power cell panel 52 is located at the top of light fixture 50. The lamp comprises a 2¼-inch diameter, 3⅛-inch high clear plastic housing lens device 54. LED 56 is positioned about 1-inch below the top of the lens. Housing lens device 54 is smooth on the outside and has about 120 vertical triangular ridges 58 on its inside surface as shown in FIG. 1B(1) that helps disperse the light produced by LED 56. A conical reflector 60 is located at the bottom of housing lens device 54 that reflects downward directed LED light in a generally horizontal direction as indicated at 62. The rechargeable batteries are shown at 66 in FIG. 1B. Also shown in FIG. 1B are base plate 68, mounting post 70, light level sensor 72, power control board 74, and lid

The LED is extremely bright so that direct viewing of it can be unpleasant. Therefore, the LED utilized is designed to produce a beam that is directed primarily downward toward the conical reflector 60 where the light is reflected generally horizontally and not toward the eyes of walking people. The lamp includes three shades 64 shown in FIG. 1A. These shades are intended to add to the beauty of the lamp.

The functionality of the existing device is explained by reference to FIG. 2. The functional blocks comprising the device are a solar cell panel 52, a light level sensor 62, an electrical power conditioning and control circuit 74, a rechargeable battery pack 66, a white light LED 56, and light dispersal optics 60 and 58. During daylight hours, the electrical power conditioning and control circuit 74 receives a threshold level signal input from the light level sensor 72. Circuit 74 then allows electrical power from the solar cell panel 52 to be transferred to the rechargeable battery pack 66 for the purpose of restoring energy to the pack. During the dark hours the light level sensor 72 does not provide the “charge” signal to the control circuitry. Circuit then direct stored battery power to the LED 56, which converts the electrical power to optical power, providing a bright, white light source. The light from the LED 56 is directed towards the light dispersal optics 58 and 60 for illumination of the region surrounding light fixture 50.

The primary problem with light fixtures of the type shown in FIGS. 1A, B and C is that they provide little illumination, a very small fraction of the illumination provided by, for example a typical outdoor light fixture housing a 10-watt incandescent lamp. What are needed are improvements that will provide better illumination from the efficient albeit lower output power LED's, typically about 10 mW.

### SUMMARY OF THE INVENTION

The present invention provides a improved solar powered LED-based lighting fixture providing substantial increases in the apparent light output compared to prior art solar powered LED-based lighting fixtures. This improvement in preferred embodiments results from the addition of inexpensive spherical lenses that create a large number of images of LED light sources, each image having substantially reduced brightness as compared to the real LED light source. These images with substantially reduced brightness result in beautiful patterns, and still appear very bright to human observers at night. In a preferred embodiment ten plastic 0.5-inch spherical lenses are positioned along the bottom edge of the cone at the bottom of the lamp. Each of these spherical lenses creates a double image of the single source LED, both very bright compared to the light coming from the same region in a lamp fixture without the spheres installed. As a result the apparent delivery of light intensity to an observer is multiplied by a factor of approximately 10 times. There is no gain in the light provided by the existing LED arrangement; rather, the light is more efficiently directed to the eyes of an observer, and to the area surrounding the light fixture. The observer sees about 10 bright images coming from a region of the fixture where none exist without the spheres installed for any given observer view point around the circumference of the sphere-containing fixture. In other preferred embodiments, conventional primary cell alkaline batteries are used in place of rechargeable Nickel-Cadmium batteries, whereby the battery cost is cut in half and the energy storage capacity tripled. Applicant has discovered that the conventional primary cell alkaline batteries are safely and effectively recharged by the solar cell.

### BREIF DESCRIPTION OF THE DRAWINGS

FIGS. 1A, 1B and 1C show features of one commercially available solar powered landscape lighting fixture according to the prior art.

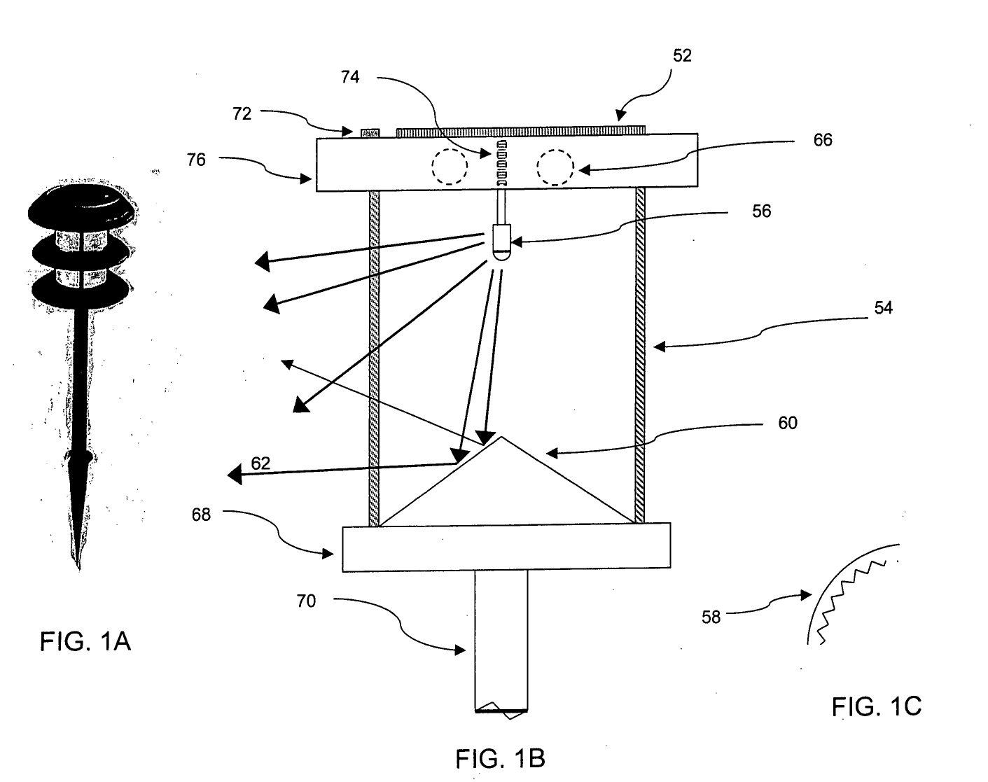

FIG. 2 shows the functional schematic layout of one commercially available solar powered landscape lighting fixture according to the prior art.

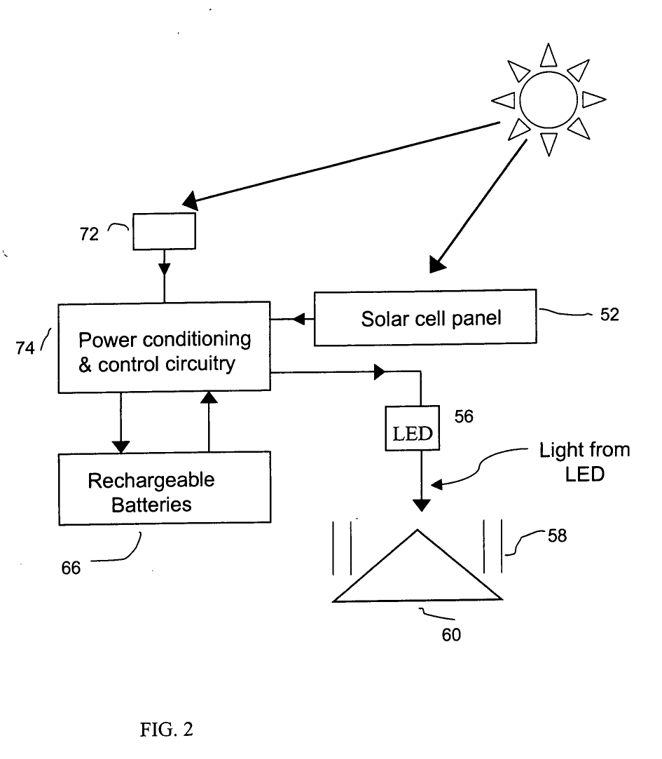

FIG. 3 shows the essential optical element of the invention, an image-forming clear plastic or glass sphere, added to a prior art optical design to greatly enhance light distribution from the white, source LED.

FIG. 4 shows a top view of all of the spheres loaded around the circumference of the lighting fixture.

FIG. 5 shows the enhanced pattern of apparent bright image sources and illumination bands afforded by one preferred embodiment of the invention over the prior art.

FIG. 6 shows the apparent source image multiplication produced by a preferred embodiment of the invention.

FIG. 7 shows the basic configuration illustrated in FIG. 6, with an additional sphere mounted on the apex of the reflective cone.

FIG. 8 illustrates the principle of refractive imaging of the lowest cost, preferred embodiment of the invention.

FIG. 9 shows the optical ray trace details of how one of the spheres, in combination with the reflective aluminized cone, forms a double image of the source LED.

FIG. 10 shows the actual visible (wavelength range 400 nm to 800 nm, nominal) spectral output from a “white” LED

FIG. 11 shows data on low current charge and discharge cycles with conventional “non-rechargeable” alkaline AA size batteries.

FIG. 12 shows measurement means of the increased optical output afforded by the addition of the transparent spheres over the prior art.

### DETAILED DESCRIPTION OF THE PREFERRED EMBODIMENTS

### First Preferred Embodiment

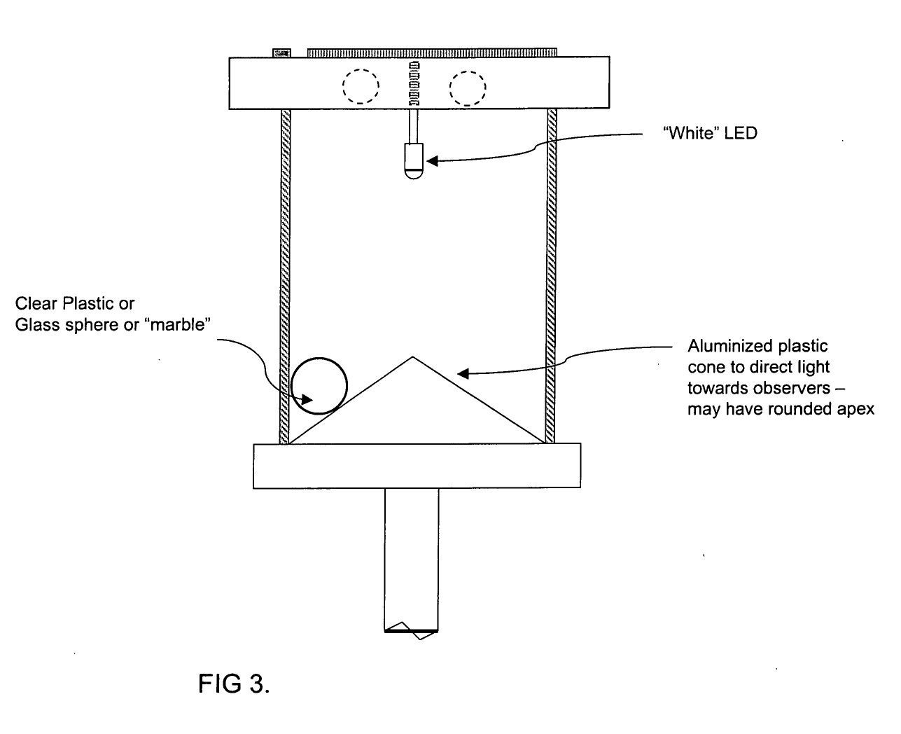

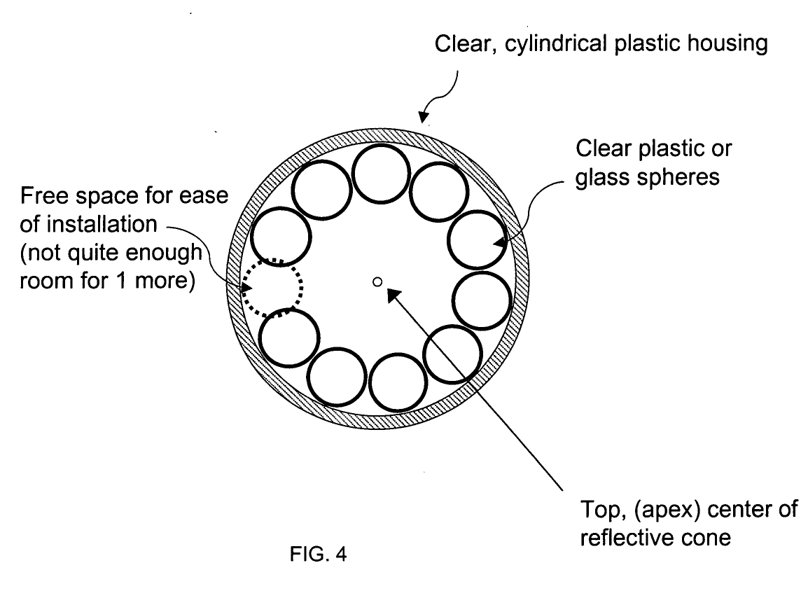

A first preferred embodiment of the present invention can be described by reference to FIGS. 3-6. An important optical element added to the existing device described in the Background Section for the purpose of enhancing the light distribution is shown in FIG. 3. This is a clear, transparent ½-inch diameter sphere made from plastic or glass that forms a widely distributed bright image of the source LED 56 close to the surface of the sphere. In FIG. 4, a top view shows that 10 of these ½-inch spheres are arrayed around the circumference of the inner wall of the 2¼ inch diameter transparent cylindrical lens. A space just smaller than the diameter of a single sphere is left in the array, so that there is no difficulty in loading the group of 10 spheres into the housing. The spheres naturally array themselves in the correct position at the circumference of lens 54 by the action of gravity and the conical reflector 60. No additional attachment is needed or desired.

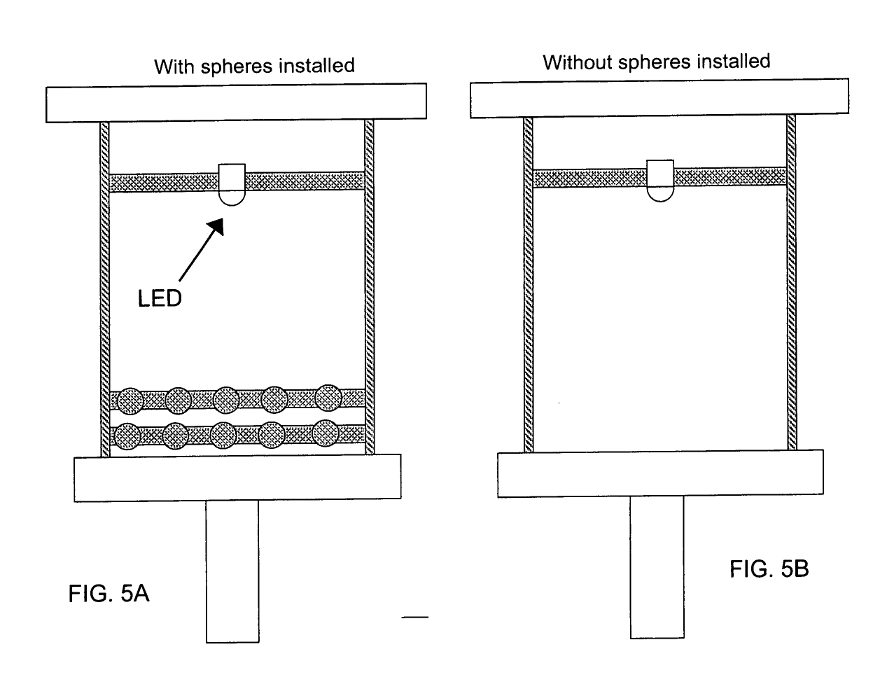

Each sphere forms a localized image of the source LED, making it appear that the housing contains many bright LEDs, instead of just one. An added feature of the configuration of the invention is that reflection of the images associated with each sphere by the aluminized cone doubles the apparent number of LED images created by a given number of spheres. The resulting change in appearance afforded by the spheres is illustrated in FIG. 5A. This appearance shown in FIG. 5A is contrasted with the appearance of the prior art device shown in FIG. 5B.

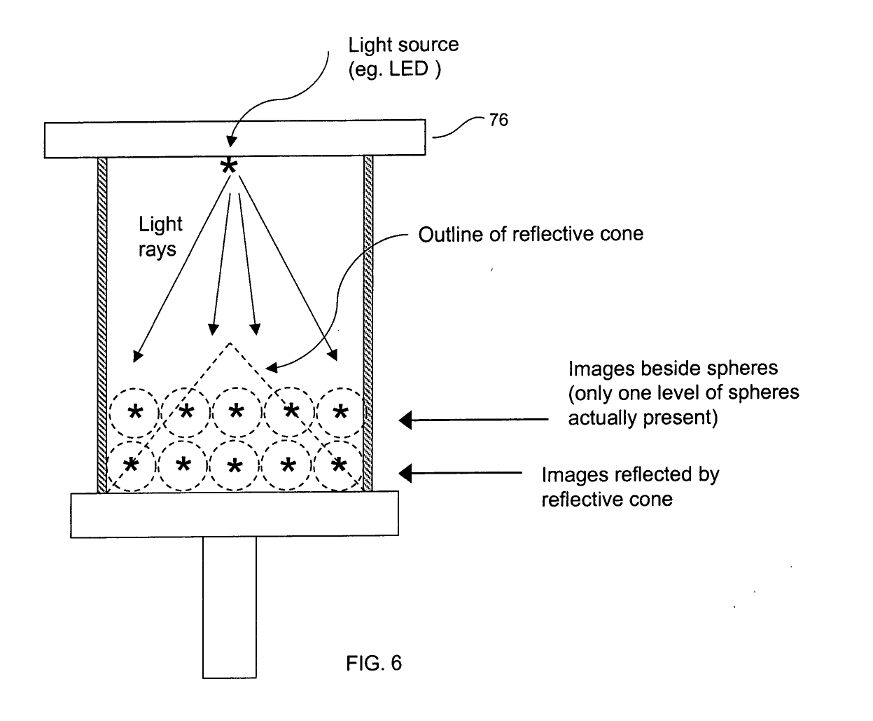

A schematic of the image locations produced by adding spheres to the original design is shown in FIG. 6. This is what an observer “sees” when looking at a lighting fixture with the spheres installed. It appears that the lower part of the fixture contains a double ring of images of the source LED. The “*” marks, indicating locations of the images in FIG. 6, are not strictly correct. This will be addressed in more detail below.

### Spherical Lenses

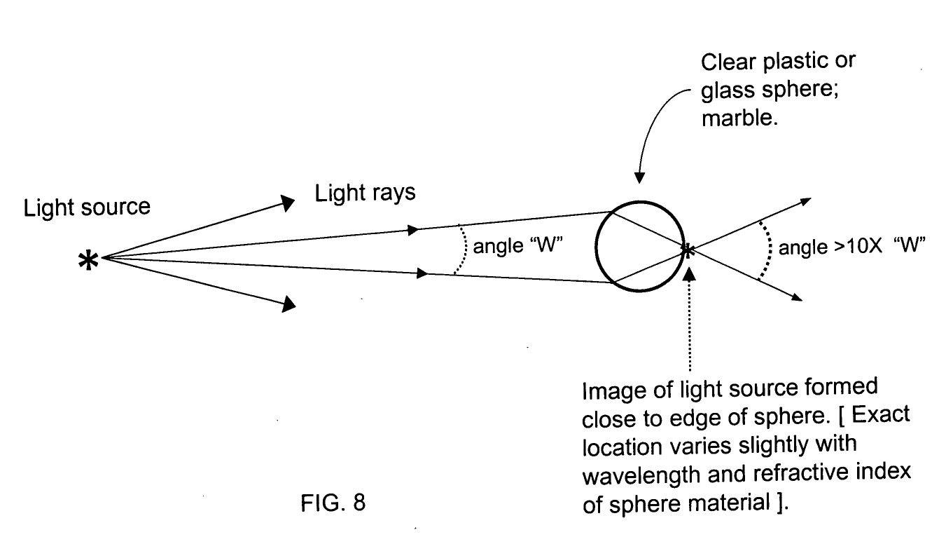

The optical diagram in FIG. 8 shows image formation by one of the transparent plastic or glass spheres. Making use of the well known “lens maker's formula”:

11/f=(n−1)×(1/r₁−1/r₂) ; where f is the focal length of the lens, n is the refractive index of the material of the spheres, and r₁ and r₂ are the radii of curvature of the front and rear surfaces of the lens; for a sphere r₁=r₂=r=radius of the sphere. Additionally, in the case of a sphere, the thickness of the “lens” is so great that the focal point lies somewhere close to the rear surface. Using a refractive index value of n=1.5 (approximate value for glass or transparent plastic) and ignoring the rear surface curvature of the sphere, the approximation can be made that 1/f≅0.5/r . Therefore: f˜2r, or the diameter of the sphere. For the application of the spheres in the landscape lighting fixtures, there is no need to go beyond the simple geometric ray tracing form of analysis in order to understand how the multiple images are formed.

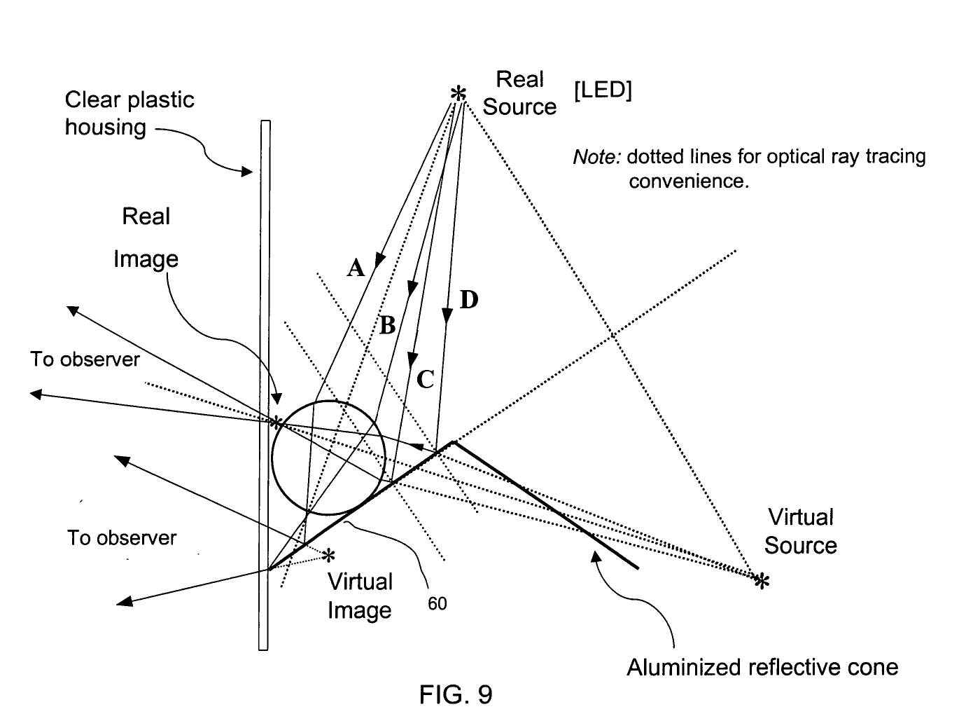

As a consequence of this imaging, the range of angles of light rays leaving the sphere is far greater than for those entering the sphere. This makes the image visible over a suitably large range of angles in the vertical plane. The actual brightness of the image is reduced by the same ratio as the angular range increase, but the white LED light source is far too bright to look at directly. Its reduced-brightness image therefore still appears to be “very bright” to a human observer. When installed in the lighting fixture, each sphere forms a double image of the source LED as depicted in FIG. 9.

As stated previously, FIG. 6 is only a schematic version of the appearance of the lighting fixture with the spheres installed, generating a double ring of images of the source LED. Only one set of spheres is actually present, but the reflective cone gives the appearance of two images per sphere, one below the other, in each case. FIG. 9, while still not a full precision ray trace, shows in principle the actual light paths that give rise to the apparent double images. Referring to FIG. 9, the bundle of light rays bounded by rays “A” and “B” are focused directly through the sphere, and then reflected by the aluminized cone 60 out of the lighting fixture. Although a real image of the LED is formed near the lower edge of the sphere, the light rays are traveling in a direction that would not be visible to an observer at some distance from the fixture. The aluminized cone on which the sphere rests reflects and redirects the rays out of the fixture to the eyes of an observer. The observer sees an image that appears to come from inside the cone surface; shown as a virtual image. A virtual image is defined as one where one cannot place a screen of any kind to observe the image. The virtual image just appears to be at the perceived location.

Again referring to FIG. 9, the bundle of light rays bounded by rays “C” and “D” are reflected from the cone surface as shown, and then focused to a real image near the surface of the actual sphere. These rays are already headed in a direction that is visible to an observer. The real image appears to be above the virtual one previously described, also with reference to FIG. 9. For completeness of description, the rays that produce the upper image appear to come from a direction that corresponds to the “virtual source” location labeled in FIG. 9. The same description applies to all of the spheres in the housing, so the observer sees what looks like a double ring of images around the circumference of the lighting fixture.

### LED's and White Light

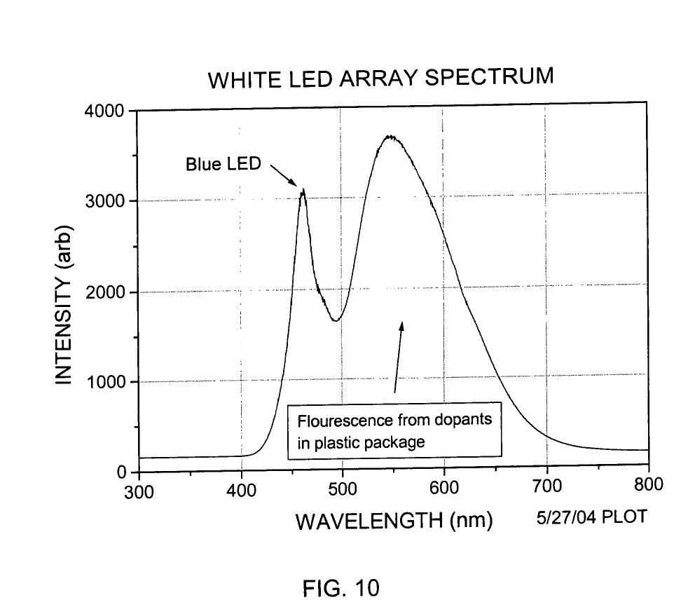

By nature, light emitting diodes do not produce a broad spectrum of wavelengths. Rather, they emit light over relatively small wavelength ranges. In the visible region, they appear red, orange, yellow, green, blue, or shades in between. Production of a white light output from LED's can be done by mixing the outputs of three individual LEDs emitting at the primary colors red, yellow and blue. More cost and space effectively, in a single LED package, white light can be produced by fabricating a high efficiency blue LED, encased in a plastic housing doped with materials that absorb some but not all of the blue light, and fluoresce at the longer wavelengths. If the dopants are present at the correct levels, the output spectrum appears to be white to the human eye. FIG. 10 shows a typical white light LED emission spectrum of the LED used in the prior art device described in the Background section and actually measured by Applicant.

### Recharging Non-Rechargeable Batteries

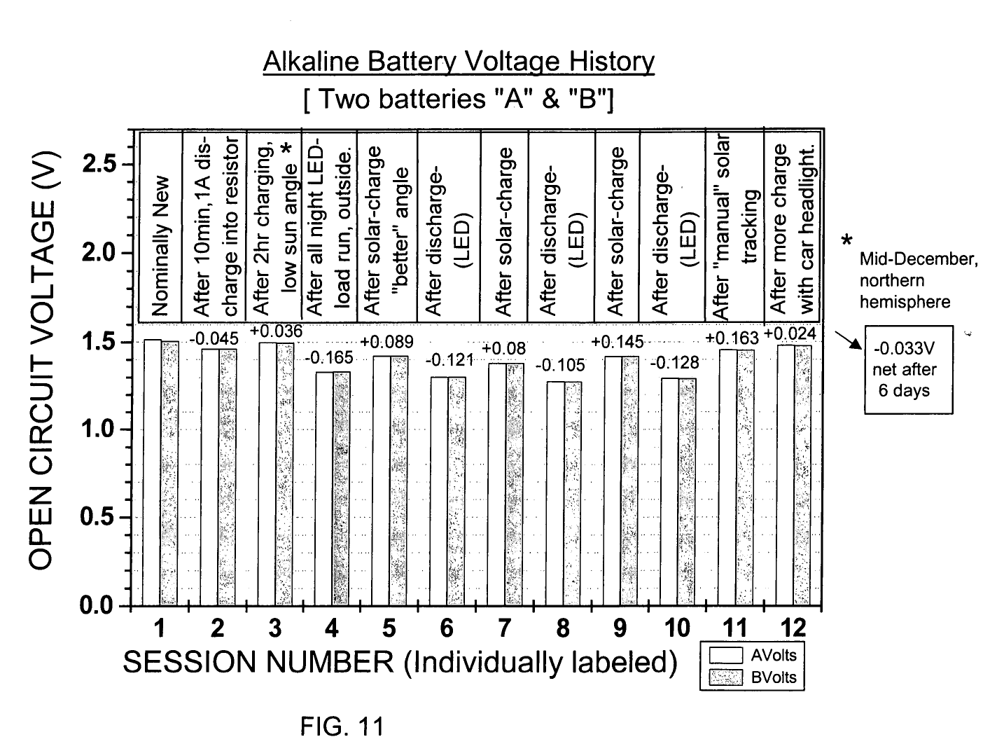

Applicant has discovered that substantial improvement in the performance of these solar powered fixtures can be realized by using “non-rechargeable alkaline batteries in place of the NiCad batteries in the prior art solar powered fixtures. Data on the rechargeability of conventional, nominally “non-rechargeable” alkaline batteries at the few tens of mA level is presented in FIG. 11. Applicant's actual experiments have shown that at least 40 charge/discharge cycles can be accommodated when the two currents are limited to the few tens of mA range, and depletion of the energy storage in the batteries is limited to approximately 10% per cycle. In one experiment, a pair of alkaline batteries which had been subjected to 30 charge/discharge cycles in a shady environment that received no direct sunshine, was placed in a fixture with full solar exposure for one day. As a result, the open circuit voltage increased from 0.94V to 1.52V. (A new alkaline cell typically has a voltage close to 1.6V.)

Referring again to FIG. 11, the voltage of a pair nearly-new non-rechargeable “AA” size alkaline batteries was measured (1.517V, 1.508V) prior to being deliberately discharged into a nominal 1 Ohm resistive load for 10 minutes. This was to simulate the approximate number of milliamp-hours (mAh) that would be expended in an overnight run in the landscape lighting fixture. This is shown as “session 1” in the figure. The batteries were then left overnight to allow any voltage-recovery phenomena to occur, and the voltage re-measured as 1.463V and 1.463V in session 2.

It should be noted that the seemingly remarkable identical voltage of the two batteries is not, in fact, surprising. Since the same amount of charge passes through the two batteries, connected in series, the number of molecules undergoing electrochemical reaction is the same for both. The process is charge-quantized, as shown in equations 1, 2, and 3, below for “non rechargeable” alkaline batteries (again, strictly speaking “primary cells”).
Zn+2 OH⁻→ZnO+H₂O+2 e⁻ equation (1)
at the cathode;
2 MnO₂+H₂O+2 e⁻→Mn₂O₃+2 OH⁻ equation (2)
at the anode.

The overall reaction is:
Zn+2MnO₂→ZnO+Mn₂O₃ E=1.5 V equation (3)

This is nothing more than the laws of chemical stoichiometry with an external source (charge) or sink (discharge) of electrons that carry the current in the electrical circuit connected to the battery terminals. The reactions are, to first order, reversible, unless excessive voltages or currents cause the formation of molecules not in the equations above.

Referring yet again to FIG. 11, the purpose of sessions 1 and 2 were to accelerate the beginning of taking of test data, and are not otherwise necessary steps in acquiring data on battery performance. In session 3, the lighting fixture was placed outside and exposed to sunlight for a part of the day, interruptions being due to shadows of trees and the like. The voltage was again measured (1.501V, 1.499V, an increase of 0.04V due to solar charging) to determine if the nominally “non-rechargeable” alkaline batteries would in fact charge at currents limited to a few tens of mA. As noted in the figure, the sun angle was quite low, being in mid-December in the Northern Hemisphere. Session 4 shows the voltage drop, down to 1.332V, after the first “real” overnight run with the LED driven by the batteries. In session 5, the fixture was tilted to point more nearly to the mid-day sun position, but no tracking attempt was made. The larger voltage increase (0.09V versus 0.04V in the previous charge cycle) was expected and was recorded in the graph, session 5. Sessions 6 through 10 were run to determine the general repeatability of the discharge/recharge cycles. Exact repetitions cannot be expected due to differences in cloud cover or light haze, and additionally to temperature fluctuations which change ionic and electronic mobility within the batteries by significant amounts.

In session 11, an attempt to manually track the sun's position was carried out by physically relocating the lighting fixture to sunny areas several times over the course of the day. The resulting improved charge voltage increase (0.163V) is shown in the graph in FIG. 11, session 11. Because of the limited number of daylight hours, additional charging was performed by illuminating the lighting fixture with a 100 W automobile headlight, driven by a 12V lead-acid car battery, for several hours. The final voltage (1.48V), recorded in session 12, was nearly the same as the nominally new voltage (1.52V), after 6 discharge/recharge cycles, thus indicating the feasibility of multiple recharging of “non-rechargeable” alkaline batteries at the tens of mA current level.

### Actual Light Level Measurements

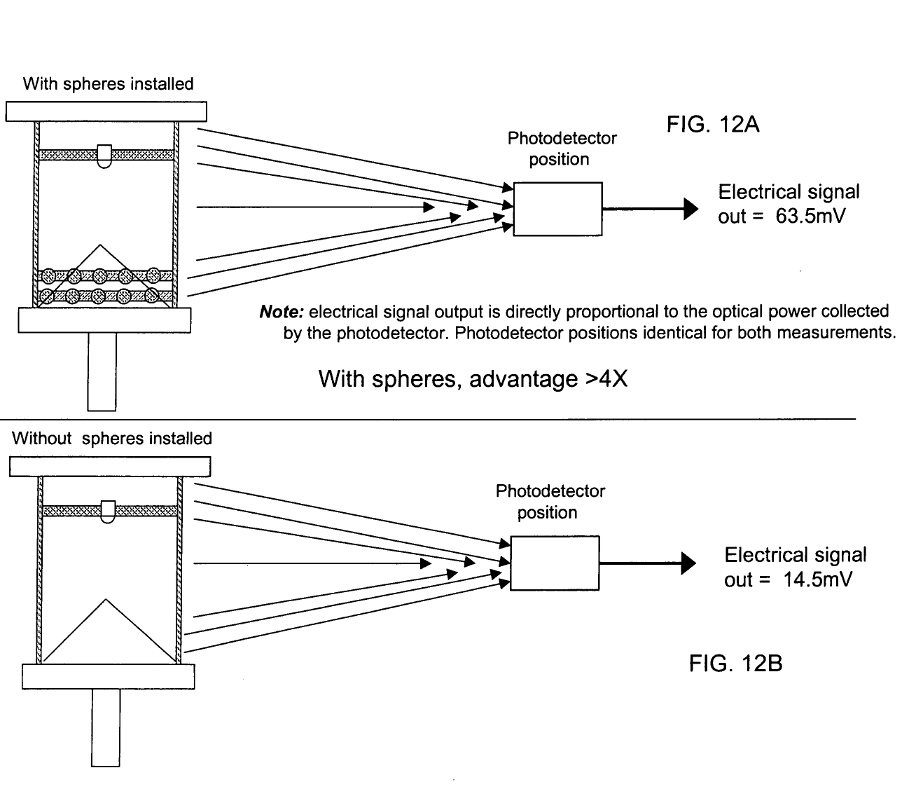

Actual measurements were made by Applicant to determine the difference in light levels delivered to an observer's eye with and without the spheres installed is illustrated in FIG. 12. The best way to measure human perception of the difference is to mimic what happens in the human eye. This was achieved by using a lens about 4 feet away from the lighting fixture, and imaging the fixture onto a diffuse glass screen, behind which was mounted a photodiode to convert incident optical power to an electrical signal level. The diffuser and photodiode mimic the human retina in terms of incident light level (although no spatial image information is recorded). The result of this test was that with the spheres present, more than 4 times as much light was collected. The two measurements were identical except for the presence or absence of the spheres in the lighting fixture. It should be noted that although the actual optical power emitted lies in the range of 4 to 5 times that without the spheres, as described in the above measurement, a human observer judges the output to increase far more due to imaging of bright spots on the retina that do not exist without the spheres. Witnesses to the invention typically say “that looks 10 times better” or “way, way better”.

### Other Embodiments

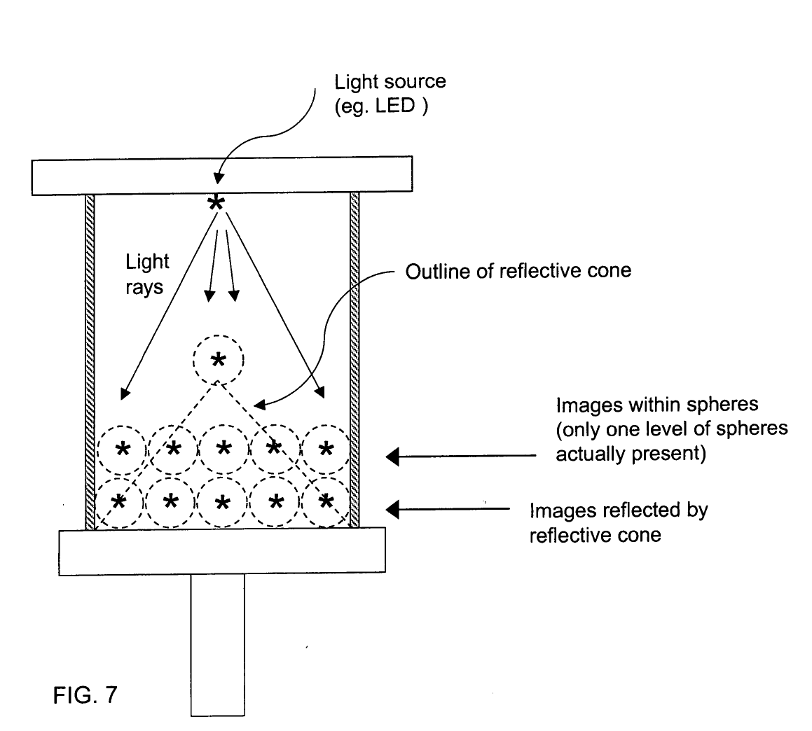

The above description of the present invention has focused on a single embodiment. The reader should understand that many variations and changes to the above description are possible without departing from the novel concepts of the present invention. For example more than one LED could be used to increase the brightness of the fixture. In some application, users may prefer colored LED's. As suggested above white light can be simulated by use of several LED's each designed to radiate at a different specific wavelength. For example, a red LED, and green LED and a blue LED properly designed using well known prior art techniques can produce white light. FIG. 7 shows the addition of another transparent sphere on the apex. Since this sphere does not intercept light traveling to the ring of spheres around the base of the cone there is no change in the appearance of the lighting fixture other that the addition of yet another image of the source LED. This embodiment could be fabricated, but may not prove to be cost effective compared to the gain in luminosity afforded by the first preferred embodiment shown in FIG. 4. Readers should note that the lid 76 as shown in FIG. 6 is removable and contains the batteries and the LED that is designed to provide a downward directed relatively narrow beam. Therefore, the lid can be lifted off the lower part of the fixture and used as a flashlight.

For these reasons, the reader should determine the scope of the present invention by the appended claims and not by the descriptions that have been given above.

We claim:

1. A solar powered lighting fixture comprising:
A) a photocell for converting electromagnetic radiation into electrical energy,
B) at least one light emitting diode
C) an electric storage device for storing electrical energy produced by said photocell and for providing power to said at least one light emitting diode,
D) an electronic control circuit for controlling the flow of electrical energy from said photocell to said electric storage device and from said electric storage device to said at least one light emitting diode,
E) light dispersing optics for dispersing light produced by said at least one light emitting diode into a desired pattern, said light dispersing optics comprising a plurality of spherical lenses.

2. The solar powered lighting fixture as in claim 1 and also comprising a light level sensor for sensing the presence or absence of a predetermined level of ambient light, wherein said control circuit is programmed to turn on said light emitting diode when said ambient light drops below said predetermined level.

3. The solar powered lighting fixture as in claim 1 and further comprising a transparent cylindrical housing lens.

4. The solar powered lighting fixture as in claim 1 wherein said plurality of spherical lenses are transparent plastic spheres.

5. The solar powered lighting fixture as in claim 4 wherein said plastic spheres are lightly colored.

6. The solar powered lighting fixture as in claim 1 wherein said plurality of spherical lenses are transparent glass spheres.

7. The solar powered lighting fixture as in claim 6 wherein said glass spheres are lightly colored.

8. The solar powered lighting fixture as in claim 1 wherein said light emitting diode comprises beam forming optical components to produce a downward directed light beam defining a beam path and said light dispersing optics comprises a conical reflector located below said light emitting diode and within said light beam said conical reflector defining a bottom circumference.

9. The solar powered lighting fixture as in claim 8 wherein said plurality of spherical lenses are positioned along the circumference of said conical reflector and along an inside circumference of said transparent cylindrical housing lens.

10. The solar powered lighting fixture as in claim 1 wherein said electrical storage device comprises at least one NiCad rechargeable batteries.

11. The solar powered lighting fixture as in claim 1 wherein said electrical storage device comprises two AA NiCad rechargeable batteries.

12. The solar powered lighting fixture as in claim 1 wherein said electrical storage device comprises at least one alkaline battery.

13. The solar powered lighting fixture as in claim 1 wherein said electrical storage device comprises two AA alkaline batteries.

14. The solar powered lighting fixture as in claim 1 wherein said electrical storage device comprises two AA non-rechargeable alkaline batteries.

15. The solar powered lighting fixture as in claim 1 wherein said electrical storage device and said at least one light emitting diode is comprised in a removable lid that can be utilized as a flashlight.
